(19) United States
(12) Patent Application Publication
(10) Pub. No.: US 2015/0230029 A1
(43) Pub. Date: Aug. 13, 2015

(54) ELECTRO ACOUSTIC TRANSDUCER

(71) Applicant: SAMSUNG ELECTRONICS CO., LTD., Suwon-si (KR)

(72) Inventors: Seog-woo HONG, Yongin-si (KR); Hyung-jae SHIN, Seongnam-si (KR); Dong-sik SHIM, Hwaseong-si (KR); Byung-gil JEONG, Anyang-si (KR); Seok-whan CHUNG, Hwaseong-si (KR)

(73) Assignee: SAMSUNG ELECTRONICS CO., LTD., Suwon-si (KR)

(21) Appl. No.: 14/317,135

(22) Filed: Jun. 27, 2014

(30) Foreign Application Priority Data
Feb. 12, 2014 (KR) 10-2014-0016281

(51) Int. Cl. H04R 23/00

(52) U.S. Cl. CPC H04R 23/00; H04R 2201/003

(57) ABSTRACT

An electro-acoustic transducer includes a conductive substrate provided with at least one cell and at least one electrode, and a pad substrate disposed corresponding to the conductive substrate and provided with at least one pad corresponding to the electrode, in which at least one of the electrode and the pad includes an electric pattern for electric connection and at least one dummy pattern that is provided around the electric pattern to be separated the electric pattern.

### CROSS-REFERENCE TO RELATED APPLICATION

This application claims priority from Korean Patent Application No. 10-2014-0016281, filed on Feb. 12, 2014, in the Korean Intellectual Property Office, the disclosure of which is incorporated herein in its entirety by reference.

### BACKGROUND

1. Field

Apparatuses and methods consistent with exemplary embodiments relate to an electro-acoustic transducer, and more particularly, to a micromachined capacitive electro-acoustic transducer.

2. Description of the Related Art

Electro-acoustic transducers convert electric energy to acoustic energy or vice versa and may include, for example, ultrasonic transducers and microphones. Micromachined electro-acoustic transducers use a micro-electro-mechanical system (MEMS). An example of the micromachined electro-acoustic transducer is a micromachined ultrasonic transducer (MUT), which is a device that converts an electric signal to an ultrasonic signal or vice versa. An MUT may be classified into a piezoelectric MUT (pMUT), a capacitive MUT (cMUT), and a magnetic MUT (mMUT), according to the signal converting method. Among these ultrasonic transducers, a cMUT is widely used in medical image diagnostic devices and/or sensors.

### SUMMARY

Exemplary embodiments may address at least the above problems and/or disadvantages and other disadvantages not described above. However, exemplary embodiment are not required to overcome the disadvantages described above, and may not overcome any of the problems described above.

One or more exemplary embodiments provide a micromachined capacitive electro-acoustic transducer.

According to an aspect of an exemplary embodiment, an electro-acoustic transducer includes a conductive substrate provided with at least one cell and at least one electrode, and a pad substrate disposed corresponding to the conductive substrate and provided with at least one pad corresponding to the at least one electrode, in which at least one of the at least one electrode and the at least one pad includes an electric pattern for electric connection and at least one dummy pattern that is provided around the electric pattern to be separated therefrom.

The at least one electrode may include an electric electrode for electric connection and at least one dummy electrode that is provided around the electric electrode to be separated therefrom. The at least one pad may include an electric pad that is bonded to the electric electrode and at least one dummy pad that is provided around the electric pad to be separated therefrom and is bonded to the at least one dummy electrode.

The at least one dummy electrode may be provided to have a one-to-one correspondence with the at least one dummy pad. One dummy electrode may correspond to a plurality of dummy pads or a plurality of dummy electrodes may correspond to one dummy pad. The at least one pad may be formed as an integral type electric pad and bonded to the electric electrode and the at least one dummy electrode. The at least one pad may include an electric pad for electric connection and at least one dummy pad that is provided around the electric pad to be separated therefrom, and the at least one electrode may be formed as an integral type electric electrode and bonded to the electric pad and the at least one dummy pad.

The at least one dummy pattern may be provided to surround the electric pattern. The at least one dummy pattern may have a continuous line shape. The at least one dummy pattern may have at least one of a dotted line shape and a dashed line shape. The at least one electrode and the at least one pad may be bonded to each other by eutectic bonding. Any one of the at least one electrode and the at least one pad may include Sn and at least one of Au, Cu, and Ag, and the other one of the at least one electrode and the at least one pad may include at least one of Au, Cu, and Ag.

An area of the electric pattern may be about 2500˜40000 μm², and a width of the at least one dummy pattern may be about 3˜50 μm. An interval between the electric pattern and the at least one dummy pattern or an interval between dummy patterns may be about 3˜50 μm.

According to another aspect of an exemplary embodiment, an electro-acoustic transducer includes a conductive substrate provided with a plurality of electrodes on one surface of the conductive substrate, and a pad substrate disposed corresponding to the conductive substrate and provided with a plurality of pads corresponding to the plurality of electrodes, in which at least one of the plurality of electrodes may include an electric electrode for electric connection and at least one dummy electrode that is provided around the electric electrode to be separated therefrom.

According to another aspect of an exemplary embodiment, an electro-acoustic transducer includes a conductive substrate provided with at least one cell and at least one electrode, a pad substrate disposed corresponding to the conductive substrate and provided with at least one pad corresponding to the at least one electrode, a support provided on the conductive substrate and forming the at least one cell, a membrane provided on the support to cover the at least one cell, and an upper electrode provided on the membrane, in which at least one of the at least one electrode and the at least one pad may include an electric pattern for electric connection and at least one dummy pattern that is provided around the electric pattern to be separated therefrom.

### BRIEF DESCRIPTION OF THE DRAWINGS

The above and/or other aspects will become more apparent by describing in detail certain exemplary embodiments, with reference to the accompanying drawings, in which:

FIG. 1 is a cross-sectional view of an example of a micromachined capacitive electro-acoustic transducer;

FIG. 2 illustrates plan views of first and second pads of FIG. 1;

FIG. 3 is a graph showing frequency response characteristics of the micromachined capacitive electro-acoustic transducer of FIG. 1;

FIG. 4 is a cross-sectional view of a micromachined capacitive electro-acoustic transducer according to an exemplary embodiment;

FIG. 5 is an enlarged view of a portion A of FIG. 4;

FIG. 6 is an enlarged view of a portion B of FIG. 4;

FIGS. 7A and 7B illustrate a plan view of a second electrode (or second pad) of FIG. 4;

FIGS. 8A and 8B illustrate plan views of first and second electrodes (or first and second pads of FIG. 4;

FIG. 9 is a graph showing frequency response characteristics of a micromachined capacitive electro-acoustic transducer according to a change in a bonding area;

FIGS. 10A and 10B illustrate a plan view of a second electrode (or second pad) according to another exemplary embodiment;

FIGS. 11A and 11B illustrate a plan view of a second electrode (or second pad) according to another exemplary embodiment;

FIGS. 12A and 12B illustrate a plan view of a second electrode (or second pad) according to another exemplary embodiment;

FIG. 13 is a cross-sectional view of a second electrode and a second pad according to another exemplary embodiment;

FIG. 14 illustrates a plan view of a second pad of FIG. 13;

FIG. 15 is a cross-sectional view of a second electrode and a second pad according to another exemplary embodiment;

FIG. 16 is a cross-sectional view of a second electrode and a second pad according to another exemplary embodiment; and

FIG. 17 is a cross-sectional view of a second electrode and a second pad according to another exemplary embodiment.

### DETAILED DESCRIPTION

Certain exemplary embodiments are described in greater detail below with reference to the accompanying drawings.

In the following description, same reference numerals are used for the same elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

The thickness or size of each layer illustrated in the drawings may be exaggerated for convenience of explanation and clarity. In the following description, when a layer is described to exist on another layer, the layer may exist directly on the other layer or a third layer may be interposed therebetween. A material forming each layer in the following exemplary embodiments is merely exemplary and thus another material may be used.

Expressions such as “at least one of,” when preceding a list of elements, modify the entire list of elements and do not modify the individual elements of the list.

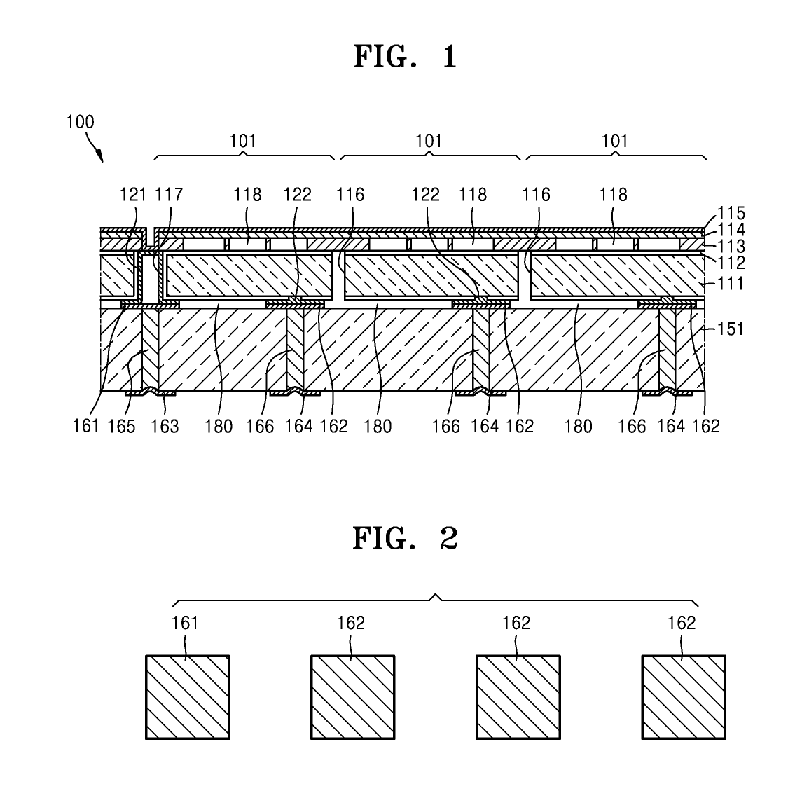

FIG. 1 is a cross-sectional view of an example of a micromachined capacitive electro-acoustic transducer 100. Referring to FIG. 1, the electro-acoustic transducer 100 includes a plurality of elements 101 that are arranged in two dimensions and each of the elements 101 includes at least one of cells 118. The elements 101 are separated from one another by a trench line 116. A support 113 in which the cells 118 are formed is provided on a conductive substrate 111. A membrane 114 that covers the cells 118 is provided on the support 113. An upper electrode 115 is provided on the membrane 114. An insulation layer 112 may be provided on a surface of the conductive substrate 111. A via hole 117 penetrates through the conductive substrate 111. A first electrode 121 is electrically connected to the upper electrode 115 via the via hole 117. The first electrode 121 is provided to extend to a lower surface of the conductive substrate 111. A plurality of second electrodes 122 are provided on a lower surface of the conductive substrate 111 to be electrically connected to the conductive substrate 111. The first electrode 121 may be a common electrode and the second electrodes 122 may be provided to correspond to the elements 101.

The conductive substrate 111 may be coupled to a pad substrate 151. In detail, a first pad 161 corresponding to the first electrode 121 and a plurality of second pads 162 corresponding to the second electrodes 122 are provided on an upper surface of the pad substrate 151. The first electrode 121 and the first pad 161 are bonded to each other and the second electrodes 122 and the second pads 162 are bonded to each other. The bonding between the first electrode 121 and the first pad 161 and the bonding between the second electrodes 122 and the second pads 162 may be performed by eutectic bonding. A first lower pad 163 connected to the first pad 161 and a plurality of second lower pads 164 connected to the second pads 162 are provided on a lower surface of the pad substrate 151. A first conductive filler 165 for electrically connecting the first pad 161 and the first lower pad 163 is provided in the pad substrate 151. A plurality of second conductive fillers 166 for electrically connecting the second pads 162 and the second lower pads 164 are provided in the pad substrate 151.

As described above, the first electrode 121 of the conductive substrate 111 and the first pad 161 of the pad substrate 151 are bonded together. The second electrodes 122 of the conductive substrate 111 and the second pads 162 of the pad substrate 151 are bonded together. FIG. 2 illustrates planes of the first pad 161 and the second pads 162 of FIG. 1. Referring to FIGS. 1 and 2, cavity areas 180 that are relatively large spaces are formed between the first and second electrodes 121 and 122 (or the first and second pads 161 and 162) that are bonded together. The cavity areas 180 may generate unnecessary vibrations of the conductive substrate 111 during driving of the electro-acoustic transducer 100. Accordingly, a frequency response characteristic may be degraded.

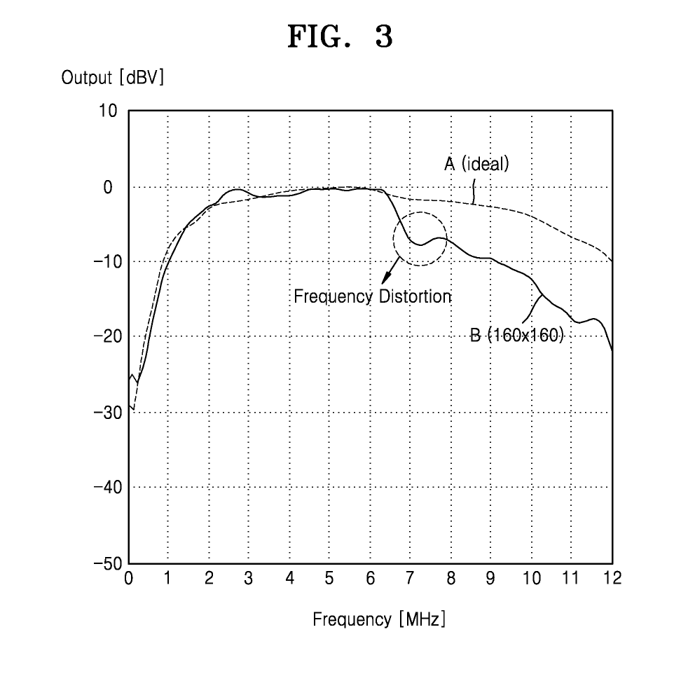

FIG. 3 is a graph showing frequency response characteristics of the micromachined capacitive electro-acoustic transducer 100 of FIG. 1. In detail, in FIG. 3, while a line A indicates an ideal frequency response characteristic of a micromachined capacitive electro-acoustic transducer, a line B indicates a frequency response characteristic occurring when a bonding area between the first and second electrodes 121 and 122 and the first and second pads 161 and 162 in the micromachined capacitive electro-acoustic transducer 100 of FIG. 1 is about 160 μm×160 μm. Referring to FIG. 3, it may be seen that, while the line A indicates an ideal frequency characteristic without frequency distortion, the line B has a frequency distortion phenomenon. The frequency distortion phenomenon may occur when the conductive substrate 111 vibrates due to the cavity areas 180 that are empty spaces existing between the bonding areas in the micromachined capacitive electro-acoustic transducer 100 of FIG. 1. As such, in the micromachined capacitive electro-acoustic transducer 100 of FIG. 1, the frequency response characteristic may be degraded due to the cavity areas 180 that are relatively large empty spaces existing between the bonding areas.

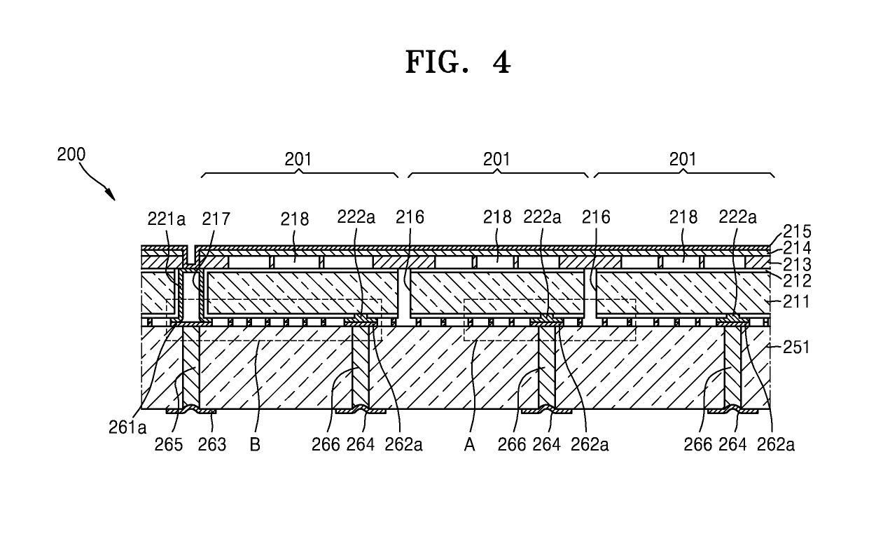

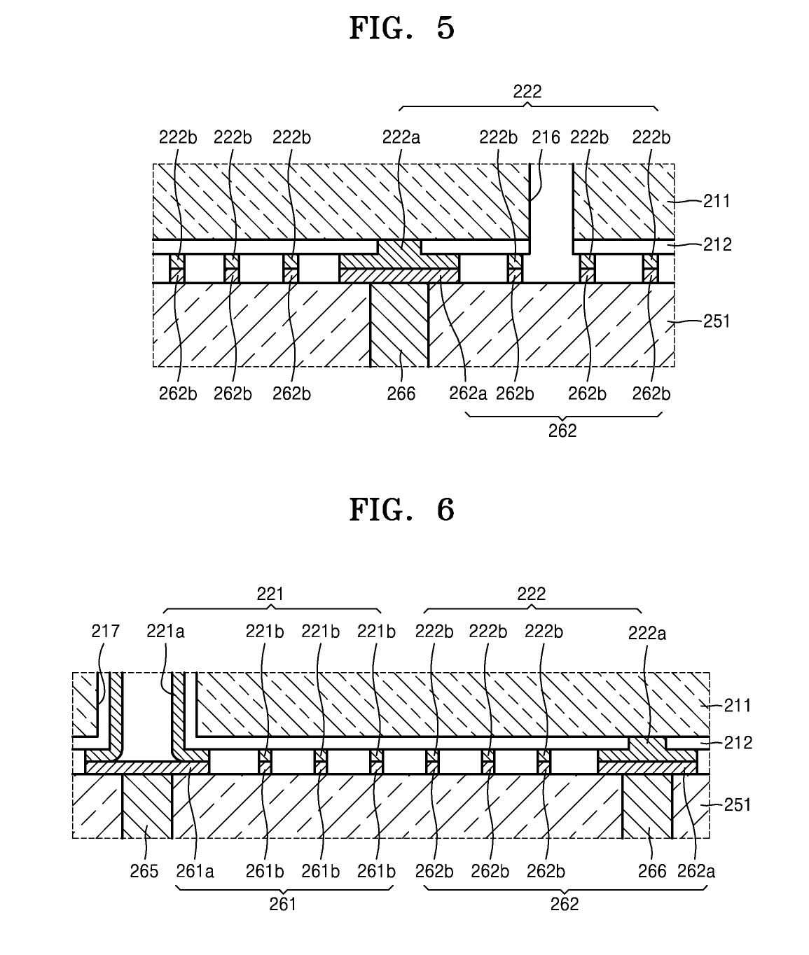

FIG. 4 is a cross-sectional view of a micromachined capacitive electro-acoustic transducer 200 according to an exemplary embodiment. FIG. 4 illustrates a part of the electro-acoustic transducer 200 for convenience of explanation. FIG. 5 is an enlarged view of a portion A of FIG. 4. FIG. 6 is an enlarged view of a portion B of FIG. 4.

Referring to FIGS. 4 to 6, the electro-acoustic transducer 200 includes a plurality of elements 201 that are arranged in two dimensions. Each of the elements 201 includes at least one of cells 218. Each of the elements 201 may be independently driven. Although FIG. 4 illustrates an example in which each of the elements 201 includes the cells 218, each of the elements 201 may include one cell 218 only. The elements 201 are separated from one another by a trench line 216 to prevent crosstalk and electrical connection between the elements 201.

The electro-acoustic transducer 200 includes a conductive substrate 211 having the cells 218 on an upper surface thereof and a plurality of first and second electrodes 221 and 222 on a lower surface thereof, and a pad substrate 251 coupled to the conductive substrate 211 and having on an upper surface thereof a plurality of pads 261 and 262 that are bonded to the first and second electrodes 221 and 222. The first and second electrodes 221 and 222 and the pads 261 and 262 respectively includes an electric pattern for electric connection and at least one dummy pattern provided around the electric pattern to be separated from the electric pattern.

The conductive substrate 211 functions as a low electrode and may include, for example, a low resistance silicon substrate. However, this is merely an example and a substrate formed of various materials may be used as the conductive substrate 211. An insulation layer 212 may be formed on an upper surface of the conductive substrate 211. Although the insulation layer 212 may include, for example, silicon oxide, an exemplary embodiment is not limited thereto. A support 213 on which the cells 218 are formed is provided on the insulation layer 212. Although the support 213 may include, for example, silicon oxide, an exemplary embodiment is not limited thereto. A membrane 214 is provided on the support 213 to cover the cells 218. Although the membrane 214 may include, for example, silicon, an exemplary embodiment is not limited thereto. An upper electrode 215 is provided on the membrane 214.

A via hole 217 is formed to penetrate through the conductive substrate 211 and insulation layer 212. The insulation layer 212 is formed on an inner wall of the via hole 217. The first electrode 221, more specifically, a first electric electrode 221a described later in detail, may be provided on the inner wall and an upper wall of the via hole 217. The first electrode 221 may extend to a lower surface of the conductive substrate 211. The first electrode 221 is electrically connected to the upper electrode 215. A trench to expose the first electrode 221 is formed in the membrane 214 and the support 213. The upper electrode 215 is connected to the first electrode 221 through the trench. The insulation layer 212 is formed on a lower surface of the conductive substrate 211. The insulation layer 212 is patterned to expose a part of the lower surface of the conductive substrate 211. The second electrodes 222 are provided on the insulation layer 212 to be electrically connected to the exposed lower surface of the conductive substrate 211. FIG. 4 illustrates an example in which the first electrode 221 is provided to be a common electrode and the second electrode 222 corresponds to the element 201. Alternatively, the first electrode 221 may be provided to correspond to the element 201 and the second electrode 222 may be provided to be a common electrode.

Each of the first electrode 221 and the second electrodes 222 includes an electric pattern for electric connection and at least one dummy pattern provided around the electric pattern to be separated therefrom. In detail, the first electrode 221 includes a first electric electrode 221a and at least one first dummy electrode 221b provided around the first electric electrode 221a to be separated therefrom. Each of the second electrodes 222 includes a second electric electrode 222a and at least one second dummy electrode 222b provided around the second electric electrode 222a to be separated therefrom.

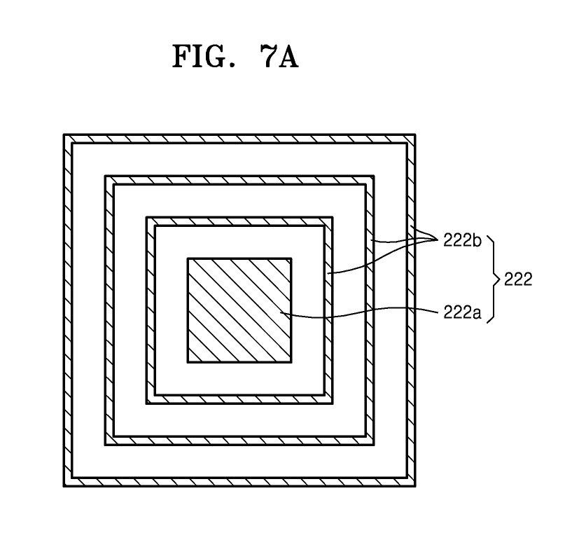

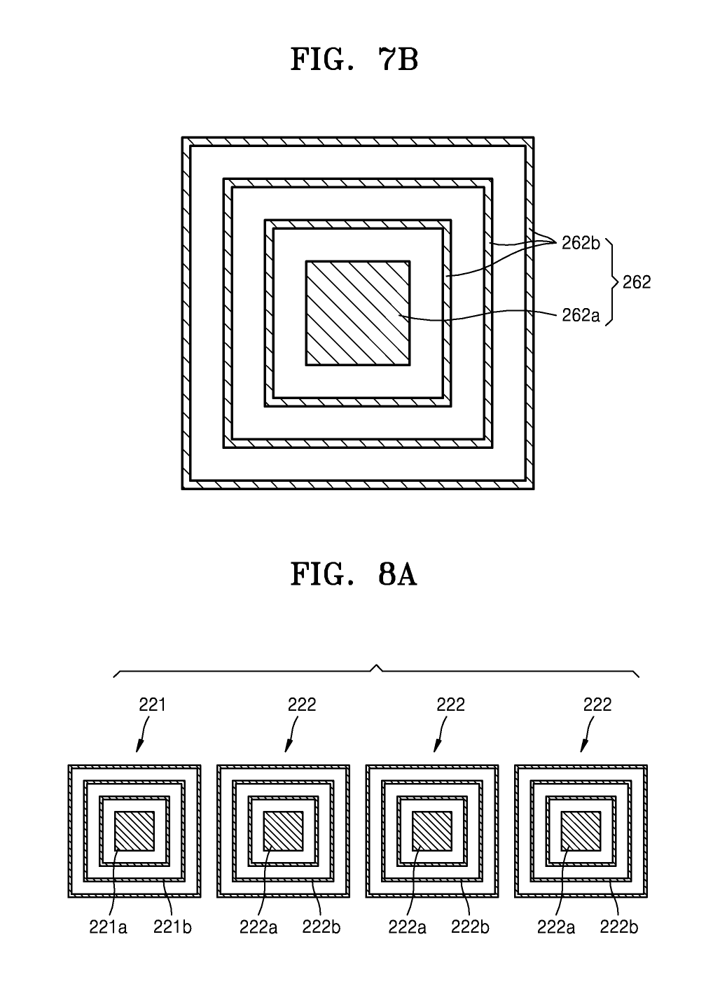

FIG. 7A illustrates a plan view of the second electrode 222 of FIG. 4. The second electrode 222 includes the second electric electrode 222a for electric connection and second dummy electrodes 222b provided around the second electric electrodes 222a to be separated therefrom. As described below, the second electric electrode 222a is bonded to a second electric pad 262a and the second dummy electrodes 222b are bonded to the second dummy pads 262b. The second electric electrode 222a is provided to contact a lower surface of the conductive substrate 211 to transfer an electric signal applied from the second electric pad 262a to the conductive substrate 211 that is a lower electrode. The second dummy electrodes 222b are bonded to the second dummy pads 262b and support the conductive substrate 211 and pad substrate 251 between the first electric electrode 221a and second electric electrode 222a (or a first electric pad 261a and the second electric pad 262a) and between the second electric electrodes 222a (or the second electric pads 262a).

Each of the second dummy electrodes 222b may have a continuous line shape surrounding the second electric electrode 222a. The second dummy electrodes 222b may be provided to be separated from each other at predetermined intervals. For example, the size of the second electric electrode 222a may be about 50×50˜200×200 μm². In this case, each of the second dummy electrodes 222b may be formed to have a width of about 3˜50 μm. The interval between the first electric electrode 222a and the second dummy electrodes 222b or the interval between the second dummy electrodes 222b may be about 3˜50 μm. However, an exemplary embodiment is not limited thereto and the second electric electrode 222a and the second dummy electrodes 222b may be formed in various sizes. Although FIG. 7A illustrates that the second dummy electrodes 222b are provided around the second electric electrode 222a, only one second dummy electrode 222b may be provided around the second electric electrode 222a. The second electrode 222 formed of the second electric electrode 222a and the second dummy electrodes 222b may include a conductive material. The second electrode 222 may include, for example, at least one of Au, Cu, and Ag. Also, the second electrode 222 may include, for example, Sn and at least one of Au, Cu, and Ag.

The first electrode 221 formed on the lower surface of the conductive substrate 211 has the same plan view as that of the second electrode 222 of FIG. 7A, except that a through hole corresponding to the via hole 217 is formed in the middle of the first electrode 221. The first electrode 221 includes the first electric electrode 221a for electric connection and the first dummy electrodes 221b provided around the first electric electrode 221a to be separated therefrom. As described below, the first electric electrode 221a is bonded to the first electric pad 261a and the first dummy electrodes 221b are bonded to a plurality of first dummy pads 261b. The first electric electrode 221 is provided to contact the upper electrode 215 and transfers an electric signal applied from the first electric pad 261a to the upper electrode 215. The first dummy electrodes 221b are bonded to the first dummy pads 261b and support the conductive substrate 211 and the pad substrate 251 between the first electric electrode 221a and the second electric electrode 222a (or the first electric pad 261a and the second electric pad 262a) and between the conductive substrate 211 and the pad substrate 251.

Each of the first dummy electrodes 221b may have a continuous line shape surrounding the first electric electrode 221a. The first dummy electrodes 221b may be provided to be separated from each other at predetermined intervals. For example, the size of the first electric electrode 221a may be about 50×50˜200×200 μm². In this case, each of the first dummy electrodes 221b may be formed to have a width of about 3˜50 μm. The interval between the first electric electrode 221a and the second dummy electrode 221b or between the first dummy electrodes 221b may be about 3˜50 μm. However, an exemplary embodiment is not limited thereto and the first electric electrode 221a and the first dummy electrodes 221b may be formed in various sizes. Alternatively, only one first dummy electrode 221b may be provided around the first electric electrode 221a. The first electrode 221 formed of the first electric electrode 221a and the first dummy electrodes 221b may include a conductive material. The first electrode 221 may include, for example, at least one of Au, Cu, and Ag. Also, the first electrode 221 may include, for example, Sn and at least one of Au, Cu, and Ag.

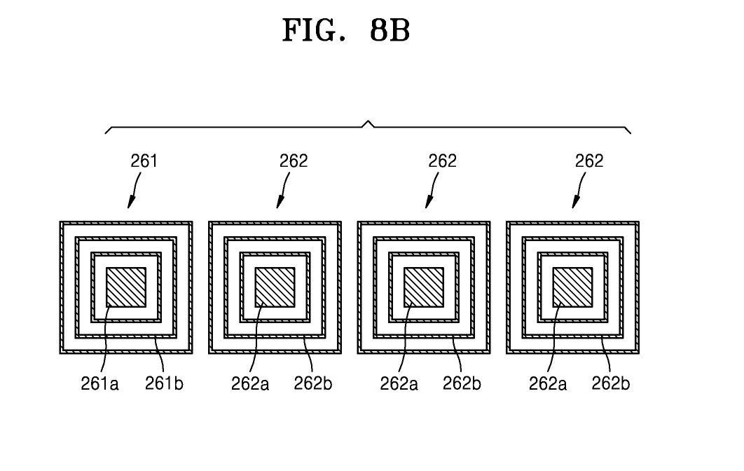

FIG. 8A illustrates plan views of the first and second electrodes 221 and 222 of FIG. 4. The first dummy electrodes 221b and the second dummy electrodes 222b are disposed between the first electric electrode 221a and second electric electrode 222a and the second dummy electrodes 222b are disposed between the second electric electrodes 222a.

The pad substrate 251 is coupled to a lower portion of the conductive substrate 211. A silicon substrate, for example, may be used as the pad substrate 251, but an exemplary embodiment is not limited thereto. The first pad 261 bonded to the first electrode 221 and the second pads 262 bonded to the second electrodes 222 are provided on an upper surface of the pad substrate 251.

FIG. 7B illustrates a plan view of the second pad 262. The second pad 262 includes the second electric pad 262a for electric connection and the second dummy pads 262b provided around the second electric pad 262a to be separated therefrom. The second dummy pads 262b may be provided to have a one-to-one correspondence with the second dummy electrodes 222b. The second electric pad 262a is bonded to the second electric electrode 222a and the second dummy pads 262b are bonded to the second dummy electrodes 222b. The second electric pad 262a applies an electric signal to the conductive substrate 211 that is a lower electrode, via the second electric electrode 222a. The second dummy pads 262b are bonded to the second dummy electrodes 222b and supports the conductive substrate 211 and the pad substrate 251 between the first electric electrode 221a and the second electric electrode 222a (or the first electric pad 261a and the second electric pad 262a) and between the second electric electrodes 222a (or the second electric pads 262a).

Each of the second dummy pads 262b may have a continuous line shape surrounding the second electric pad 262a. The second dummy pads 262b may be provided to be separated from each other at predetermined intervals. The second electric pad 262a and the second dummy pads 262b may have sizes corresponding to those of the above-described second electric electrode 222a and second dummy electrodes 222b. Although FIG. 7B illustrates that the second dummy pads 262b are provided around the second electric pad 262a, only one second dummy pad 262b may be provided around the second electric pad 262a. The second pad 262 formed of the second electric pad 262a and the second dummy pads 262b may include a conductive material. The second pad 262 may include, for example, Sn and at least one of Au, Cu, and Ag. Also, the second pad 262 may include, for example, at least one of Au, Cu, and Ag.

The second pad 262 and the second electrode 222, that is, the second electric pad 262a and the second electric electrode 222a, and the second dummy pads 262b and the second electric electrodes 222b may be bonded to each other by eutectic bonding. For example, when the second pad 262 is formed of an Au/Sn layer and the second electrode 222 is formed of an Au layer, or the second pad 262 is formed of an Au layer and the second electrode 222 is formed of an Au/Sn layer, if the second pad 262 and the second electrode 222 are eutectic bonded, an Au—Sn alloy may be formed on a boundary surface between the second pad 262 and the second electrode 222. Alternatively, the second pad 262 and the second electrode 222 may be bonded in various bonding methods in addition to the above-described eutectic bonding method.

The first pad 261 has the same plan view as that of the second pad 262 of FIG. 7B. The first pad 261 includes the first electric pad 261a for electric connection and the first dummy pads 261b provided around the first electric pad 261a to be separated therefrom. The first dummy pads 261b may have a one-to-one correspondence with the first dummy electrodes 221b. The first electric pad 261a is bonded to the first electric electrode 221a and the first dummy pads 261b are bonded to the first dummy electrodes 221b. The first electric pad 261a applies an electric signal to the upper electrode 215 via the first electric electrode 221a. The first dummy pads 261b are bonded to the first dummy electrodes 221b and support the conductive substrate 211 and the pad substrate 251 between the first electric electrode 221a and the second electric electrode 221b (or the first electric pad 261a and the second electric pad 262a). Each of the first dummy pads 261b may have a continuous line shape surrounding the first electric pad 261a. The first dummy pads 261b may be provided to be separated from each other at predetermined intervals. The first electric pad 261a and the first dummy pads 261b may have sizes corresponding to those of the above-described first electric electrode 221a and first dummy electrodes 221b. Alternatively, only one first dummy pad 261b may be provided around the first electric pad 261a.

The first pad 261 formed of the first electric pad 261a and the first dummy pads 261b may include a conductive material. The first pad 261 may include, for example, at least one of Au, Cu, and Ag. Also, the first pad 261 may include, for example, Sn and at least one of Au, Cu, and Ag. Like the bonding of the second pad 262 and the second electrode 222, the first pad 261 and the first electrode 221, that is, the first electric pad 261a and the first electric electrode 221a, and the first dummy pads 261b and the first dummy electrodes 221a, may be bonded by eutectic bonding. However, an exemplary embodiment is not limited thereto.

FIG. 8B illustrates plan views of the first pad 261 and the second pads 262 of FIG. 4. The first dummy pads 261b and the second dummy pads 262b are disposed around the first electric pad 261a and the second electric pad 262a.

A first lower pad 263 and a plurality of second lower pads 264 may be provided on a lower surface of the pad substrate 251. The first lower pad 263 is electrically connected to the first electric pad 261a of the first pad 261. The second lower pads 264 are electrically connected to the second electric pads 262a of the second pads 262. To this end, a plurality of through holes are formed in the pad substrate 251. The through holes may be provided with a first conductive filler 265 for connecting the first electric pad 261a and the first lower pad 263 and second conductive fillers 266 for connecting the second electric pads 262a and the second lower pads 264. Meanwhile, although it is not illustrated in the drawings, a driving circuit substrate, for example, an application specific integrated circuit (ASIC) substrate, for applying an electric signal to the first and second lower pads 263 and 264 may be provided under the pad substrate 251.

As described above, a first dummy pattern, that is, the first dummy electrode 221b and the first dummy pad 261b that are bonded to each other, and a second dummy pattern, that is, the second dummy electrodes 222b and the second dummy pad 262b that are bonded to each other, support the conductive substrate 211 and the pad substrate 251 in an empty space between the first electric electrode 221a and the second electric electrode 222a (or the first electric pad 261a and the second electric pad 262a). The second dummy pattern, that is, the second dummy electrodes 222b and the second dummy pad 262b that are bonded to each other, supports the conductive substrate 211 and pad substrate 251 in the empty space between the second electric electrodes 222a (or the second electric pads 262a). As such, unnecessary vibration of the conductive substrate 211 that may occur due to the empty space formed between the conductive substrate 211 and the pad substrate 251 may be prevented by the support of the first and second dummy patterns. Accordingly, a superior frequency response characteristic may be obtained even in a wide frequency range. Also, since a bonding area may be reduced, a pressure applied to a unit area during bonding may be reduced and also a short circuit that may occur between adjoining electrodes may be prevented. Alternatively, although the above description describes that the pad substrate 251 is used as a substrate that electrically connects the conductive substrate 211 and the driving circuit substrate, the pad substrate 251 may be used as the driving circuit substrate so as to be directly coupled to the conductive substrate 211.

FIG. 9 is a graph showing frequency response characteristics of a micromachined capacitive electro-acoustic transducer according to a change in a bonding area. In detail, in FIG. 9, a line A indicates an ideal frequency response characteristic of a micromachined capacitive electro-acoustic transducer and lines B, C and D indicate frequency response characteristics that occur when the bonding areas between the first and second electrodes 121 and 122 and the first and second pads 161 and 162 of the micromachined capacitive electro-acoustic transducer 100 of FIG. 1 are about 160 μm×160 μm, 190 μm×190 μm, and 210 μm×210 μm, respectively. Referring to FIG. 9, as indicated by the lines B, C and D, it may be seen that, when the bonding area is small, a frequency distortion phenomenon occurs in a low frequency range and, when a bonding area increases, the frequency distortion phenomenon occurs in a high frequency range. This is because the empty space existing between the bonding areas gradually decreases as the bonding area increases. Meanwhile, although the frequency distortion phenomenon may decrease as the bonding area increases, a possibility of a short circuit occurring between adjoining electrodes increases. In an exemplary embodiment, as dummy patterns are provided around electrode patterns, the empty space formed between the conductive substrate 211 and the pad substrate 251 may be greatly reduced. Accordingly, the frequency distortion phenomenon that occurs due to the unnecessary vibration of the conductive substrate 211 may be prevented and thus a superior frequency response characteristic may be obtained in a wide frequency range. Also, since the bonding area may be reduced, the short circuit that occurs between the adjoining electrodes may be prevented.

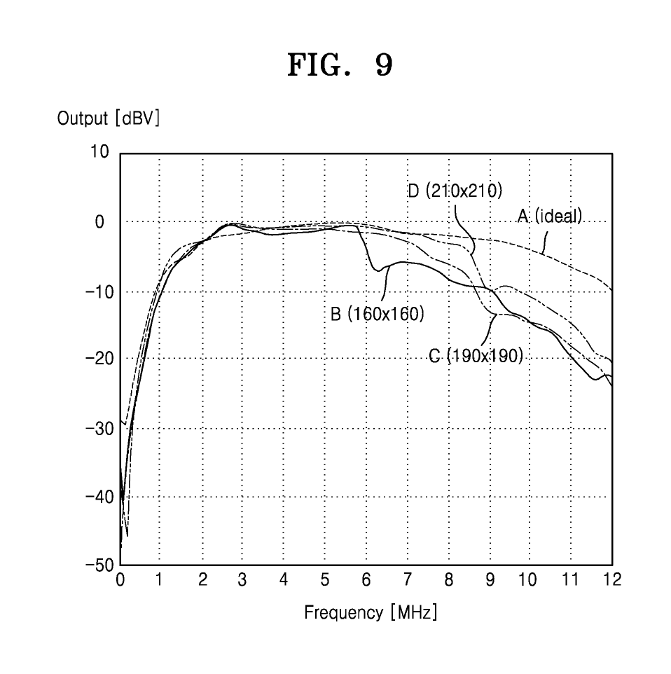

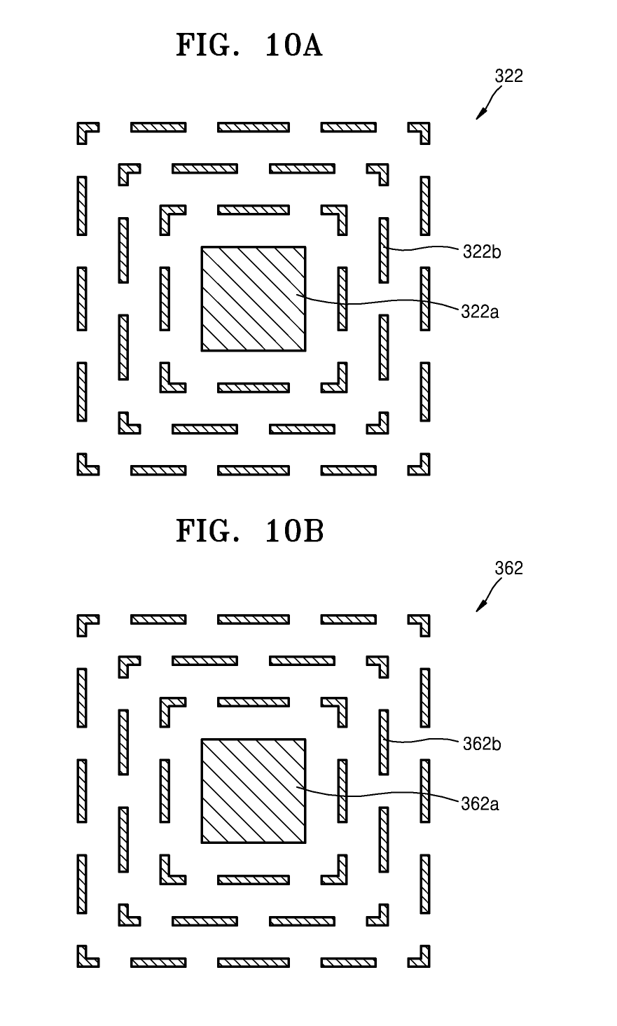

FIGS. 10A and 10B illustrate a plan view of a second electrode 322 (or a second pad 362) according to another exemplary embodiment. The second electrode 322 includes a second electric electrode 322a for electric connection and a plurality of second dummy electrodes 322b that are provided around the second electric electrode 322a to be separated therefrom. Each of the second dummy electrodes 322b may have a dashed line shape surrounding the second electric electrode 322a. Alternatively, only one second dummy electrode 322b may be provided around the second electric electrode 322a. The second pad 362 includes a second electric pad 362a for electric connection and a plurality of second dummy pads 362b that are provided around the second electric pad 362a to be separated therefrom. Each of the second dummy pads 362b may have a dashed line shape. Alternatively, only one second dummy pad 362b may be provided around the second electric pad 362a. The second electric electrode 322a is bonded to the second electric pad 362a. The second dummy electrodes 322b are bonded to the second dummy pads 362b. The second dummy electrodes 362b are bonded to the second dummy pads 322b and support the conductive substrate 211 and the pad substrate 251. Alternatively, a first electrode (not shown) that is connected to the upper electrode and a first pad (not shown) that is connected to the first electrode may have the same shapes as those of the above-described second electrode 322 and second pad 362.

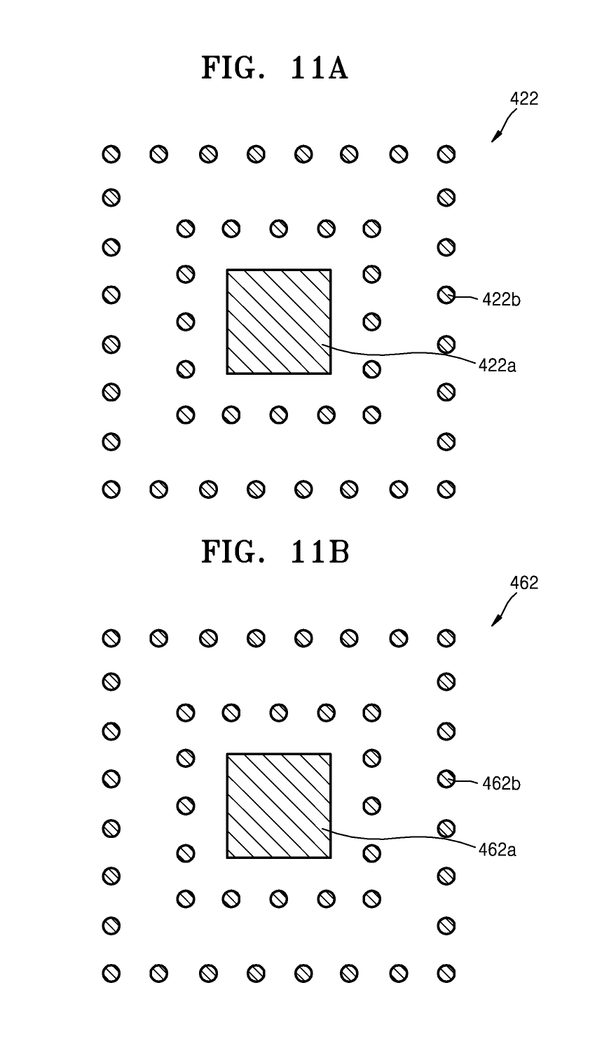

FIGS. 11A and 11B illustrate a plan view of a second electrode 422 (or a second pad 462) according to another exemplary embodiment. The second electrode 422 includes a second electric electrode 422a for electric connection and a plurality of second dummy electrodes 422b that are provided around the second electric electrode 422a to be separated therefrom. Each of the second dummy electrodes 422b may have a dotted line shape surrounding the second electric electrode 422a. Alternatively, only one second dummy electrode 422b may be provided around the second electric electrode 422a. The second pad 462 includes a second electric pad 462a for electric connection and a plurality of second dummy pads 462b that are provided around the second electric pad 462a to be separated therefrom. Each of the second dummy pads 462b may have a dotted line shape. Alternatively, only one second dummy pad 462b may be provided around the second electric pad 462a. The second electric electrode 422a is bonded to the second electric pad 462a. The second dummy electrodes 422b are bonded to the second dummy pads 462b. The second dummy electrodes 422b are bonded to the second dummy pads 462b and support the conductive substrate 211 and the pad substrate 251. A first electrode (not shown) that is connected to the upper electrode 215 and a first pad (not shown) that is bonded to the first electrode may have the same shapes as those of the above-described second electrode 422 and second pad 462. Alternatively, the second dummy electrode 422b and the second dummy pad 462b may have a dotted and dashed line shape, respectively.

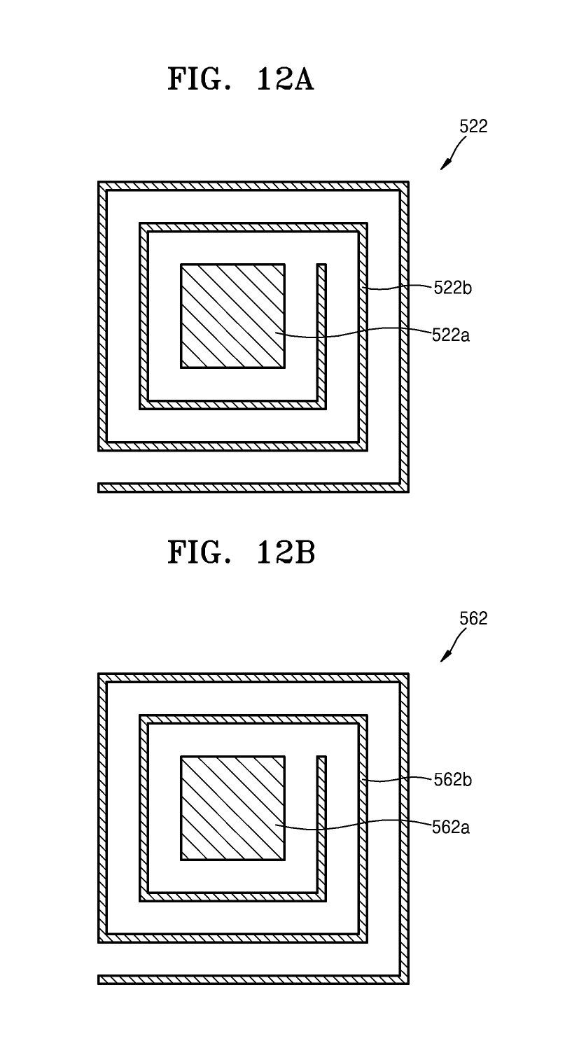

FIGS. 12A and 12B illustrate a plan view of a second electrode 522 (or a second pad 562) according to another exemplary embodiment. The second electrode 522 includes a second electric electrode 522a for electric connection and a second dummy electrode 522b that is provided around the second electric electrode 522a to be separated therefrom. The second dummy electrode 522b may have a spiral continuous line shape surrounding the second electric electrode 522a. The second pad 562 includes a second electric pad 562a for electric connection and a second dummy pad 562b that is provided around the second electric pad 562a to be separated therefrom. The second dummy pad 562b may have a spiral continuous line shape surrounding the second electric pad 562a. A first electrode (not shown) that is connected to the upper electrode 215 and a first pad (not shown) that is bonded to the first electrode may have the same shapes as those of the above-described second electrode 522 and second pad 562. In addition, the second electrode 522 and the second pad 562 may have a variety of shapes.

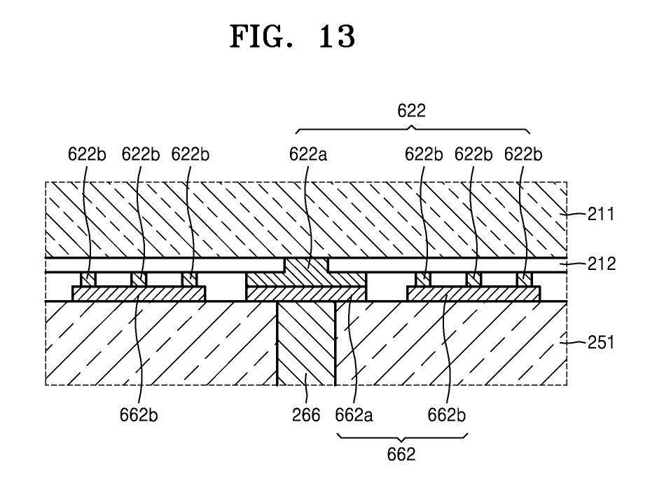

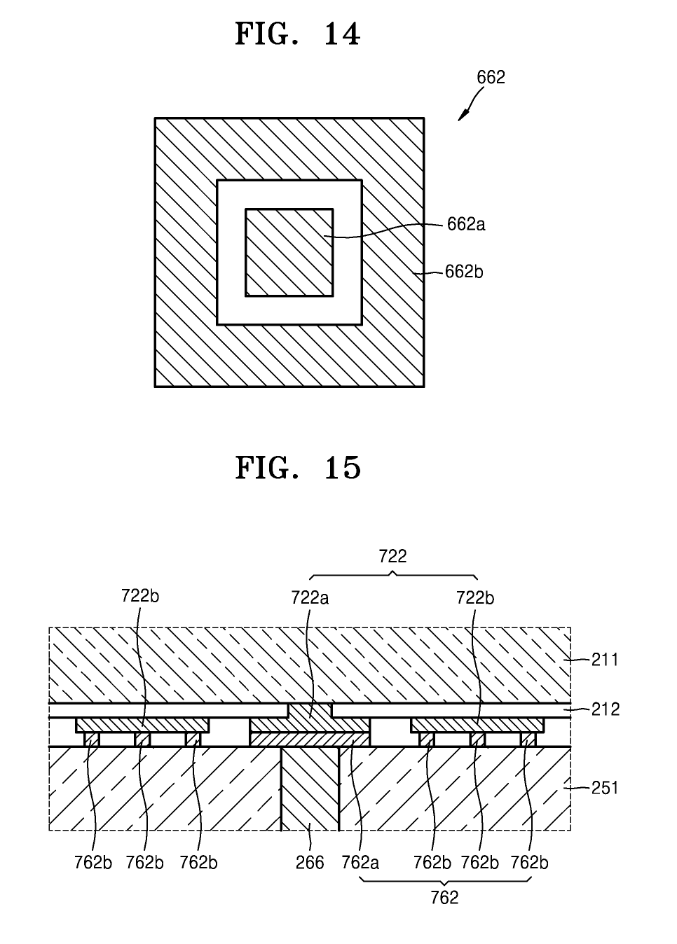

FIG. 13 is a cross-sectional view of a second electrode 622 and a second pad 662 according to another exemplary embodiment. FIG. 14 illustrates a plan view of the second pad 662 of FIG. 13. Referring to FIGS. 13 and 14, the second electrode 622 includes a second electric electrode 622a for electric connection and a plurality of second dummy electrodes 622b that are provided around the second electric electrode 622a to be separated therefrom. Each of the second dummy electrodes 622b may have a variety of shapes such as a continuous line shape, a dotted line shape, or a dashed line shape. The second pad 662 includes a second electric pad 662a for electric connection and a second dummy pad 662b that is provided around the second electric pad 662a to be separated therefrom. The second dummy pad 662b is provided to correspond to the second dummy electrodes 622b. The second electric electrode 622a is bonded to the second electric pad 662a. The second dummy electrodes 622b is bonded to the second dummy pad 662b. The second dummy electrodes 622b are bonded to the second dummy pad 662b and support the conductive substrate 211 and the pad substrate 251. Meanwhile, a first electrode (not shown) that is connected to the upper electrode 215 may have the same shape as that of the second electrode 622 and a first pad (not shown) that is bonded to the first electrode may have the same shape as that of the second pad 662.

FIG. 15 is a cross-sectional view of a second electrode 722 and a second pad 762 according to another exemplary embodiment. Referring to FIG. 15, the second electrode 722 includes a second electric electrode 722a for electric connection and a second dummy electrode 722b that is provided around the second electric electrode 762a to be separated therefrom. The second electrode 722 has the same plane shape as that of the second pad 662 of FIG. 14. The second pad 762 includes a second electric pad 762a for electric connection and a plurality of second dummy pads 762b that are provided around the second electric pad 762a to be separated therefrom. The second dummy pads 762b are provided to correspond to one second dummy electrode 722b. Each of the second dummy pads 762b may have a variety of shapes such as a continuous line shape, a dotted line shape, or a dashed line shape. The second electric electrode 722a is bonded to the second electric pad 762a. The second dummy electrode 722b is bonded to the second dummy pads 762b. The second dummy electrode 722b is bonded to the second dummy pads 762b and supports the conductive substrate 211 and the pad substrate 251. Meanwhile, a first electrode (not shown) that is connected to the upper electrode 215 may have the same shape as that of the second electrode 722. A first pad that is bonded to the first electrode may have the same shape as that of the second pad 762.

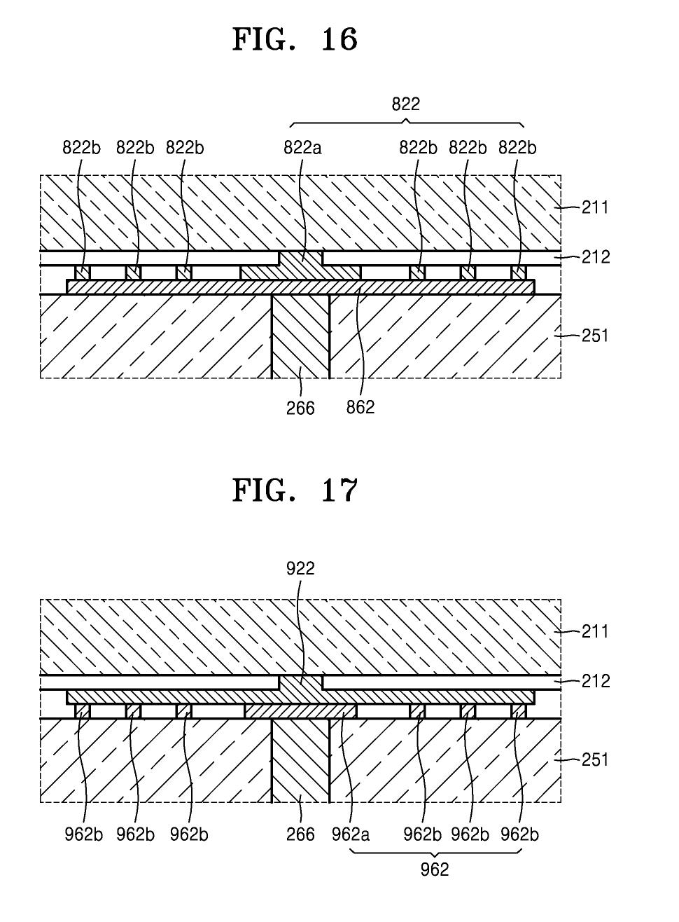

FIG. 16 is a cross-sectional view of a second electrode 822 and a second pad 862 according to another exemplary embodiment. Referring to FIG. 16, the second electrode 822 includes a second electric electrode 822a for electric connection and a plurality of second dummy electrodes 822b that are provided around the second electric electrode 822a to be separated therefrom. Alternatively, only one second dummy electrode 822b may be provided around the second electric electrode 822a. Each of the second dummy electrodes 822b may have a variety of shapes such as a continuous line shape, a dotted line shape, or a dashed line shape. The second pad 862 may be formed in an integral type electric pad. The second pad 862 is provided to correspond to the second electric electrode 822a and the second dummy electrodes 822b. Accordingly, the second pad 862 may be bonded to the second electric electrode 822a and the second dummy electrodes 822b. The second pad 862 applies an electric signal to the conductive substrate 211 that is a lower electrode, via the second electric electrode 822a. The second pad 862 is bonded to the second dummy electrodes 822b and supports the conductive substrate 211 and the pad substrate 251. Meanwhile, a first electrode (not shown) that is connected to the upper electrode 215 may have the same shape as that of the second electrode 822. A first pad (not shown) that is bonded to the first electrode may have the same shape as that of the second pad 862.

FIG. 17 is a cross-sectional view of a second electrode 922 and a second pad 962 according to another exemplary embodiment. Referring to FIG. 17, the second electrode 922 may be formed as an integral type electric electrode. The second pad 962 includes a second electric pad 962a for electric connection and a plurality of second dummy pads 962b that are provided around the second electric pad 962a to be separated therefrom. Alternatively, only one second dummy pad 962b may be provided around the second electric pad 962a. Each of the second dummy pads 962b may have a variety of shapes such as a continuous line shape, a dotted line shape, or a dashed line shape. The second electric pad 962a and the second dummy pads 962b are provided to correspond to the second electrode 922. Accordingly, the second electrode 922 may be bonded to the second electric pad 962a and the second dummy pads 962b. The second electrode 922 applies an electric signal to the conductive substrate 211 that is a lower electrode, via the second electric pad 962a. The second electrode 82 is bonded to the second dummy pads 962b and supports the conductive substrate 211 and the pad substrate 251. Meanwhile, a first electrode (not shown) that is connected to the upper electrode 215 may have the same shape as that of the second electrode 922. A first pad (not shown) that is bonded to the first electrode may have the same shape as that of second pad 962.

As described above, according to the electro-acoustic transducer according to the one or more of the above embodiments of the present invention, since the dummy patterns that support the conductive substrate and the pad substrate are provided around the electric pattern for electric connection, the unnecessary vibration that occurs due to the empty space formed between the conductive substrate and the pad substrate may be prevented. Accordingly, a frequency response characteristic in a wide frequency range may be improved. Also, since the bonding area may be reduced, a pressure applied for each unit area during bonding may be reduced. Furthermore, a short circuit that may occur between the adjoining electrodes may be prevented.

The foregoing exemplary embodiments and advantages are merely exemplary and are not to be construed as limiting. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An electro-acoustic transducer comprising:
a conductive substrate provided with a cell and an electrode; and
a pad substrate disposed to correspond to the conductive substrate and provided with a pad corresponding to the electrode,
wherein at least one of the electrode and the pad comprises an electric pattern for electrical connection and a dummy pattern that is provided around the electric pattern to be separated from the electric pattern.

2. The electro-acoustic transducer of claim 1, wherein the electrode comprises:
an electric electrode for electrical connection; and
a dummy electrode that is provided around the electric electrode to be separated from the electric electrode.

3. The electro-acoustic transducer of claim 2, wherein the pad comprises:
an electric pad that is bonded to the electric electrode; and
a dummy pad that is bonded to the dummy electrode and is provided around the electric pad to be separated from the electric pad.

4. The electro-acoustic transducer of claim 3, wherein the electrode comprises a plurality of dummy electrodes and the pad comprises a plurality of dummy pads, and
each of the plurality of dummy electrodes is provided to have a one-to-one correspondence with each of the plurality of dummy pads.

5. The electro-acoustic transducer of claim 3, wherein one dummy electrode corresponds to a plurality of dummy pads or a plurality of dummy electrodes correspond to one dummy pad.

6. The electro-acoustic transducer of claim 2, wherein the pad is formed as an integral type electric pad and is bonded to the electric electrode and the dummy electrode.

7. The electro-acoustic transducer of claim 1, wherein the pad comprises:
an electric pad for electrical connection and a dummy pad that is provided around the electric pad to be separated from the electric pad, and
wherein the electrode is formed as an integral type electric electrode and is bonded to the electric pad and the dummy pad.

8. The electro-acoustic transducer of claim 1, wherein the dummy pattern is provided to surround the electric pattern.

9. The electro-acoustic transducer of claim 8, wherein the dummy pattern has a continuous line shape.

10. The electro-acoustic transducer of claim 8, wherein the dummy pattern has at least one of a discontinuous dotted line shape and a discontinuous dashed line shape.

11. The electro-acoustic transducer of claim 1, wherein the electrode and the pad are bonded to each other by eutectic bonding.

12. The electro-acoustic transducer of claim 1, wherein one of the electrode and the pad comprises tin (Sn) and at least one of gold (Au), copper (Cu), and silver (Ag), and the other one of the electrode and the pad comprises at least one of Au, Cu, and Ag.

13. The electro-acoustic transducer of claim 1, wherein an area of the electric pattern is from about 2500 μm² to about 40000 μm², and
a width of the dummy pattern is from about 3 μm to about 50 μm.

14. The electro-acoustic transducer of claim 1, wherein a distance between the electric pattern and the dummy pattern is from about 3 μm to about 50 μm, and, when a number of dummy patterns is provided around the electric pattern, a distance between at least two adjacent dummy patterns is from about 3 μm to about 50 μm.

15. An electro-acoustic transducer comprising:
a conductive substrate provided with electrodes on one surface of the conductive substrate; and
a pad substrate disposed to correspond to the conductive substrate and provided with pads corresponding to the electrodes,
wherein at least one of the electrodes comprises an electric electrode for electrical connection and a dummy electrode that is provided around the electric electrode to be separated from the electric electrode.

16. The electro-acoustic transducer of claim 15, wherein at least one of the pads comprises an electric pad that is bonded to the electric electrode and a dummy pad that is bonded to the dummy electrode and is provided around the electric pad to be separated the electric pad.

17. The electro-acoustic transducer of claim 15, wherein the dummy electrode is provided to surround the electric electrode, and comprises at least one of a continuous line shape, a discontinuous dotted line shape, and a discontinuous dashed line shape.

18. The electro-acoustic transducer of claim 15, wherein one of the electrodes and the pads comprise Sn and at least one of Au, Cu, and Ag, and the other one of the electrodes and the pads comprise at least one of Au, Cu, and Ag.

19. The electro-acoustic transducer of claim 15, wherein an area of the electric electrode is from about 2500 μm² to about 40000 μm², and
a width of the dummy electrode is from about 3 μm to about 50 μm.

20. The electro-acoustic transducer of claim 15, wherein an interval between the electric electrode and the dummy electrode is from about 3 μm to about 50 μm.

21. An electro-acoustic transducer comprising:
a conductive substrate provided with a cell and an electrode;
a pad substrate disposed to correspond to the conductive substrate and provided with a pad corresponding to the electrode;
a support provided on the conductive substrate and forming the cell;
a membrane provided on the support to cover the cell; and
an upper electrode provided on the membrane,
wherein at least one of the electrode and the pad comprises an electric pattern for electrical connection and a dummy pattern that is provided around the electric pattern to be separated the electric pattern.
